(19) United States
(12) Patent Application Publication
(10) Pub. No.: US 2022/0071842 A1
(43) Pub. Date: Mar. 10, 2022

(54) Adjustable Acupressure Clamp

(71) Applicant: Sarah Short, Renton, WA (US)

(72) Inventor: Sarah Short, Renton, WA (US)

(21) Appl. No.: 17/012,674

(22) Filed: Sep. 4, 2020

(51) Int. Cl. A61H 39/04

(52) U.S. Cl. CPC A61H 39/04; A61H 2205/065; A61H 2201/165

(57) ABSTRACT

An acupressure clamp provides adjustable pressure for treatment. A U-shaped base comprised of flexible resilient material provides tension for application of pressure through loci on the clamp to the treatment area. A means is provided for adjustably restraining the tension that is applied, thereby enabling user control of the amount of pressure received from the clamp.

### BACKGROUND OF THE INVENTION

### Field of the Invention

This invention relates to clamps for providing therapeutic acupressure to parts of the body. More specifically, this invention relates to adjustable clamps for application of acupressure to extremities such as hands.

### Description of the Related Art

Acupressure is a popular method of alternative medical treatment, based upon a concept of “meridians”. As conceived in Asian medical doctrines such as traditional Chinese medicine and the Ayruvedic medicine known as Marma therapy, meridians are believed to be conduits of a life energy, or “chi”, that flows through the body. In these paradigms, ailments are held to be blockages of the flow of chi through the meridians. Acupressure is a discipline directed to relieve blockages of chi by the application of controlled pressure to specific locations on the body understood to correspond to the meridians.

Acupressure may be practiced manually, that is by applying a controlled amount of pressure by hand to the location in question. To improve on delivery of acupressure, however, a number of instruments have been devised for applying acupressure to specified locations. For example, U.S. Pat. No. 5,078,728 to Giarratano describes a device comprising an adjustable strap with a protuberance for providing pressure to a specific spot on the forearm of a user. Two such devices, one on each forearm of the user, provide the therapeutic treatment claimed for this invention. Along these lines, U.S. Pat. No. 5,667,484 to Brossard describes a method of using a belt-with-protuberance device similar to that of Giarratano to provide specific amounts of pressure directly above the dorsal radiocarpal ligament claimed to achieve a therapeutic effect.

Similarly, U.S. publication number 2015/0224025 by Darna describes a belt-with-protuberance device that may be adjustably tightened to provide a desired amount of pressure via the protuberance, in this case the device further provided with a therapeutic substance.

The belt with protuberance arrangement, such as described above, enables the user to vary the amount of pressure applied for acupressure at the protuberance. However, the design does not easily accommodate application of pressure to areas of extremities such as to digits or to the region between the thumb and forefinger. U.S. Pat. No. 7,101,345 to Liu is directed to a device for the application of acupressure to fingers. However, Liu's device does not provide inherent adjustable pressure, relying instead on manual compression to apply acupressure.

U.S. Pat. No. 8,137,379 to Labash describes a device providing inherent adjustable pressure for acupressure. In limitation, though, while Labash's device may be suitable for acupressure for areas such as limbs, its design may be cumbersome for application to smaller areas, such as digital extremities.

U. S. publication number 2017/0326028 and U.S. design Pat. No. Des. 670,396, both by Doogan, describe acupressure clamps that may be adapted to apply pressure to smaller or more challenging areas, such as the span between the thumb and the index finger. However, Doogan's clamps are not adjustable for applying variable pressure to the treatment area.

What is needed is an acupressure clamp that inherently applies acupressure. What is needed further is such a clamp in which the pressure to be applied is finely adjustable. Further, what is needed is such a clamp that is of simple design, facilitating ease of manufacture. Yet further still, what is needed is such a clamp of a size and configuration suitable for application to smaller and more challenging areas of the body, such as parts of the hand and foot.

### SUMMARY OF THE INVENTION

An acupressure clamp provides adjustable pressure to a user's treatment area by way of a U-shaped strip of flexible resilient material serving as a base, each arm of the U being a planar surface having an interior side opposing the corresponding interior side of the other arm. Proximate its end and distal from the bend of the U, each arm has a protruding locus on its interior side, the opposing loci on the interior sides of the arms aligning in opposition for the application of requisite pressure resulting from tension from the resilient base material to a specific treatment area. In embodiments of the clamp, an arm's locus is fashioned as a domed bulge on the arm's interior side. Advantageously, a means is provided for adjustably restraining the tension between the arms, whereby the amount of pressure applied to the treatment area by the clamp at the loci may be adjusted by the user. In some embodiments, this means is an adjustable screw inserted between the arms, intermediate the bend of the U and the loci, the screw threadedly engaged to provide the requisite adjustable restraint of tension. Embodiments may provide a knob for user adjustment of the applied pressure. Some embodiments provide a cover over the bend of the U of the base, covering the portion of the interior of the base in which the adjustment means is disposed. In embodiments providing a screw for an adjustment means, those employing a cover may provide an aperture through which the adjustment screw is inserted, allowing the knob to remain outside the cover for user access.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a perspective view of an embodiment of the invention;

FIG. 2 is a perspective view of another embodiment of the invention;

FIG. 3 is a perspective view of the base in an embodiment of the invention;

FIG. 4 is an exploded view of an embodiment of the invention;

FIG. 5 is an exploded view of the knob and adjustment screw in an embodiment of the invention;

FIG. 6 is a view of an embodiment of the invention having a cover; and

FIG. 7 is a representation of an embodiment of the invention in use to provide pressure to user's hand.

### DETAILED DESCRIPTION OF THE INVENTION

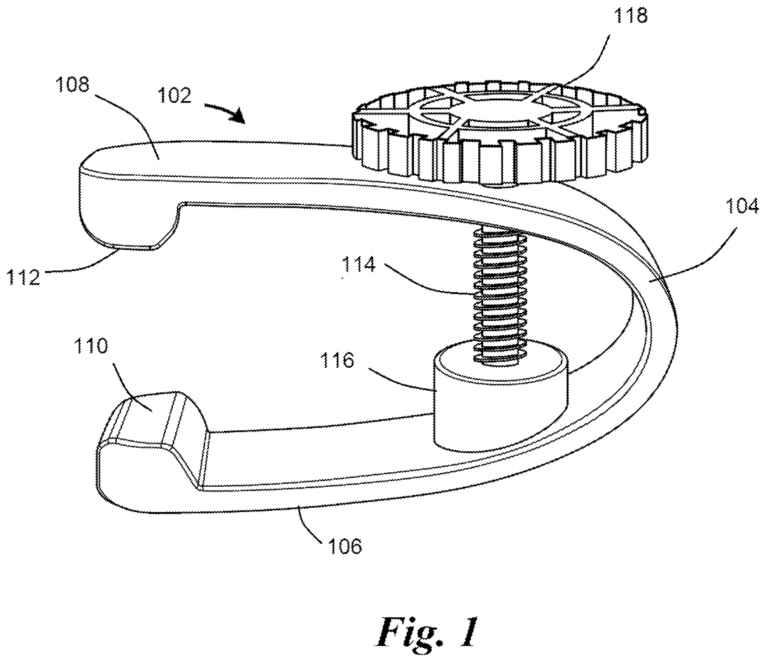

Turning now to the drawings, FIG. 1 is perspective view of an embodiment of the invention. Clamp 102 comprises a U-shaped base 104 of resilient material having lower arm 106 and upper arm 108. At the terminus of lower arm 106 is lower bulge 110 and at the terminus of upper arm 108 is upper bulge 112. An adjustment screw 114 is threadedly engaged through upper arm 108, extending down to apply or relieve pressure at pressure point 116 located on the inside surface of lower arm 106. An adjustment knob 118 is affixed to the top of adjustment screw 114. By rotating adjustment knob 118, a user can adjust the pressure applied by adjustment screw 114 to pressure point 116, thereby opening and closing the gap between arms 106, 108, enabling user adjustment of the pressure applied by upper bulge 112 and lower bulge 110 to a treatment area disposed therein between.

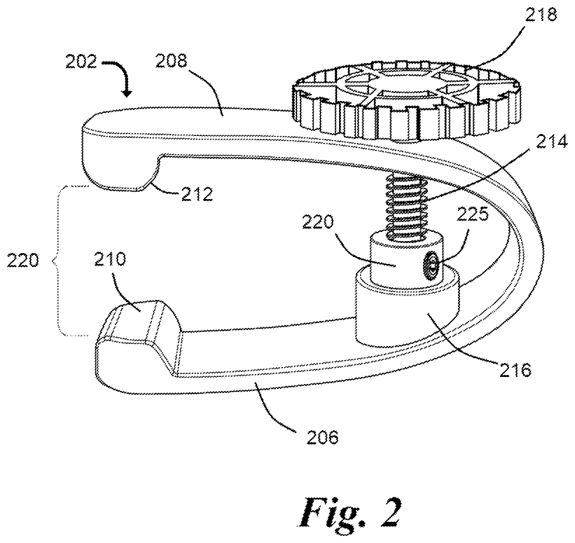

FIG. 2 depicts an additional embodiment of a clamp 202, in which a lock collar 220 is affixed with set screw 225 to the lower end of adjustment screw 214, lock collar 220 rotatably disposed on top of pressure point 216. The rotation of adjustment screw 214 by use of adjustment knob 218 adjustably displaces the distance between upper arm 208 and lower arm 206, thereby adjusting the gap 222 between upper bulge 212 and lower bulge 210 and hence the pressure applied in gap 222 by the resiliency of U-shaped base 204.

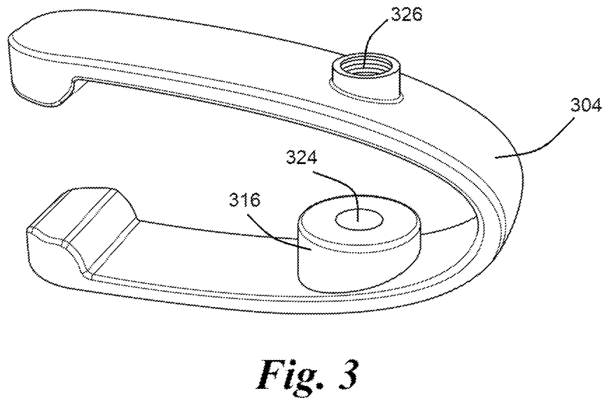

FIG. 3 is a perspective view of the U-shaped base 304 of an embodiment of the invention. A threaded aperture 324 is provided in upper arm 308 to receive the threads of an adjustment screw. An unthreaded aperture 326 is provided in pressure point 316 to receive the end of an adjustment screw threaded through threaded aperture 324.

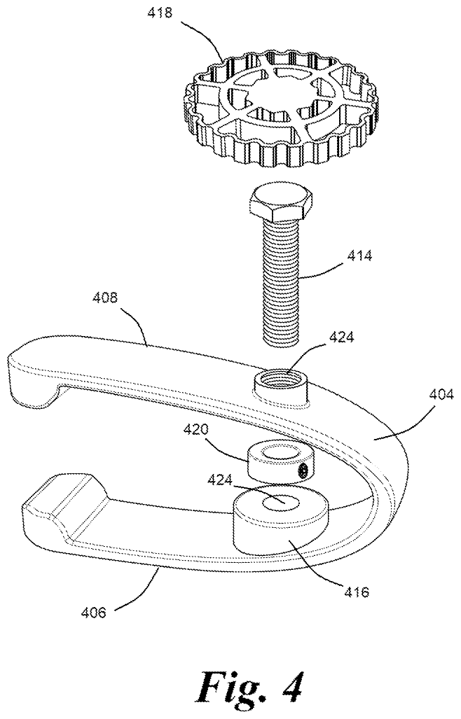

FIG. 4 is an exploded view of an embodiment of the invention along the lines of that depicted in FIG. 2. Adjustment knob 418 is affixed to adjustment screw 414, which is threadedly engaged in threaded aperture 424 in base 404. Lock collar 420 affixes to adjustment screw 414 mediate arms 406, 408 to rest on pressure point 416 on base 404. In assembly, a portion of adjustment screw 414 protrudes below lock collar 420 to engage rotatably in unthreaded aperture 424 in pressure point 416.

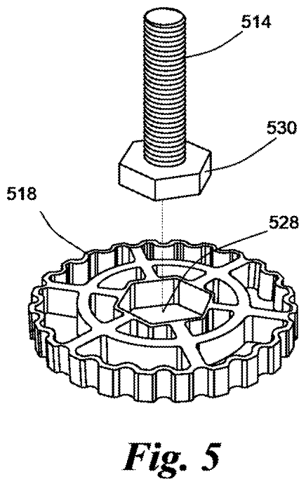

FIG. 5 depicts adjustment components for an embodiment of the clamp. Shown is adjustment knob 518, on the lower side of which is an hexagonal receptable 528 for receiving and affixing the hexagonal head 530 of the adjustment screw 514.

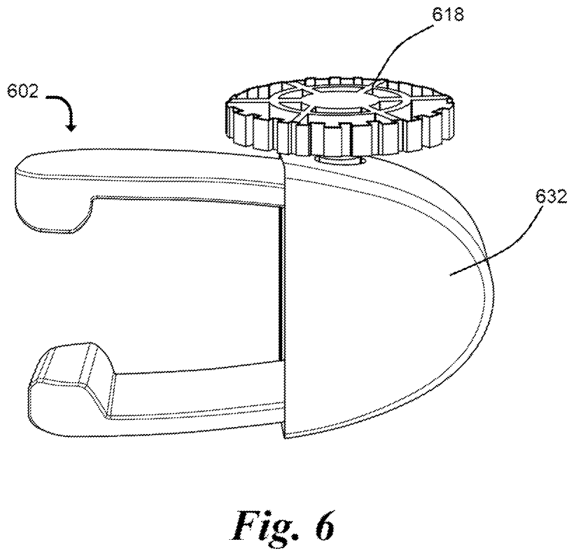

FIG. 6 illustrates a perspective view of an embodiment of the invention, wherein a cover 632 is affixed to the clamp 602, the adjustment screw (not visible) inserted through a hole in cover 632, leaving the adjustment knob 618 accessible to the user outside cover 632.

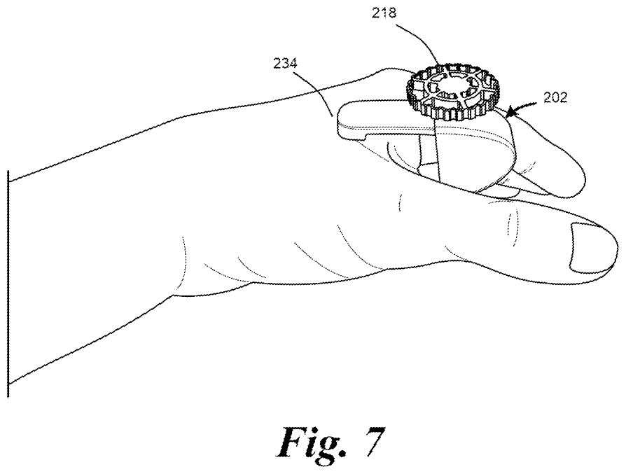

FIG. 7 shows an embodiment of the invention as portrayed in FIG. 2 in use. To use the clamp 202, the adjustment knob 218 is rotated to cause the adjustment screw 214 to lower, pressing collar restrain the resiliency of the arms 206, 208 of clamp 202, widening the gap 222 between lower bulge 210 and upper bulge 212. The clamp thus widened is slid over the treatment area 234, in this case a hand. The adjustment knob 218 is then rotated as desired to cause adjustment screw 214 to relax some of the restraint on the resiliency of arms 206, 208, thereby closing gap 222 on treatment area 234, transferring some of the resiliency of arms 206, 208 through bulges 210, 212 to provide the amount of pressure desired by the user to the treatment area 234.

Embodiments of the invention rely on the resiliency of the material from which the base of the clamp is fabricated. Suitable materials include glycol-containing polyethylene terephthalate (PETG), formed as a U-shaped sheet which in some embodiments may be in the range of 2-4 mm in thickness. A PETG base for embodiments may be fabricated by injection molding. Because PETG filament is a common feedstock for 3-D printing, bases for some embodiments may instead be printed. Alternatively, thermoforming may be used for some components of a base in some embodiments comprising PETG. In other embodiments, other resilient materials may be selected to comprise the base. Such other materials including other plastics such as high density polyethylene and metals such as spring steel. What is needed is that the composition and dimensions of the base material are such that the clamp through its resiliency applies appropriate adjustable pressure when in use.

In the embodiments illustrated, the invention employs upper and lower bulges that are integral to the base of the clamp. However, as will be appreciated by those of skill in the art, other embodiments may affix discrete components, mechanically or by appropriate adhesive, to the interior terminuses of the invention's upper and lower arms in order to provide the upper and lower bulges employed by the invention. Such discrete components may be fabricated of the same material as that used for the base of the invention. Alternatively, discrete bulges may be fashioned of other materials, including in particular malleable rubberlike materials such as latex that provide comfortable application of pressure to the treatment area.

Embodiments may employ a steel screw for the adjustment screw of the invention. Alternatively, the adjustment screw may be made of other dense rigid material, including plastics such as nylon. The knob, which can be fashioned of any rigid material, may be discrete from the adjustment screw as illustrated in the drawings. In such embodiments, the discrete knob is affixed to the screw, and this may be accomplished mechanically, as by a bolt, or by adhesion with an appropriate permanent adhesive such as cyanoacrylate glue. Alternatively, the knob may be integral to the adjustment screw, the knob and screw as a unit formed by an appropriate process such as injection molding.

While embodiments depicted in the drawings employ a screw mechanism for adjusting the pressure applied by the clamp by restraining tension between the arms of the base, other means for adjusting acupressure are contemplated by the present invention. For example, the means for adjusting the pressure applied by the resiliency of the clamp's base may comprise, in the alternative, a lockable pinion operating on a rack, the pinion serving to restrain the tension from the base acting on its arms. In yet other embodiments, such means is supplied by the operation of a stop restraining the arms, the stop slidable to engage along a bar between the arms of the base. Embodiments may yet alternatively employ a user controlled ratchet mechanism comprising, for example, a releasable pawl engaging a toothed track. The present invention contemplates all such means and their equivalents for adjustably restraining the tension from the resilient base that otherwise acts to squeeze the loci closer together.

For embodiments provided with a cover, the cover may be fashioned by injection molding, thermoforming or vacuum forming of any appropriate rigid or semi-rigid plastic material, such as polyethylene, ABS plastic or polystyrene. Alternatively, a cover may be extruded in 3-D printing from filament material such as PETG and the like. Persons in the manufacturing arts have these and many other processes and materials available from which to form a suitable cover for such embodiments.

While the invention has been described with a certain degree of particularity, it should be recognized that elements thereof may be altered by persons skilled in the art without departing from the spirit and scope of the invention. Accordingly, the present invention is not intended to be limited to the specific forms set forth in this specification, but on the contrary, it is intended to cover such alternatives, modifications and equivalents as can be reasonably included within the scope of the invention. The invention is limited only by the following claims and their equivalents.

I claim:

1. An adjustable acupressure clamp, comprising:
a base fashioned in a U-shape to form a bend extending to an upper arm and a lower arm, the bend flexible to provide a variable resilient pressure between the upper arm and the lower arm;
the upper arm having a top surface and a lower surface and further having an upper arm terminus, distal the bend, the upper arm comprising:
an upper bulge on the lower surface proximate the upper arm terminus;
the lower arm having an upper surface and further having a lower arm terminus, distal the bend, the lower arm comprising:
a lower bulge on the upper surface proximate the lower arm terminus aligning with the upper bulge;
further comprising a user controlled means for restraining the variable resilient pressure between the upper arm and the lower arm.

2. The adjustable acupressure clamp according to claim 1, wherein:
the upper arm further comprises a threaded aperture, mediate the bend and the upper arm terminus;
the lower arm further comprises a pressure point on the upper surface, mediate the bend and the lower arm terminus, aligning with the threaded aperture; and
the user controlled means for restraining the variable resilient pressure between the upper arm and the lower arm comprises an adjustment screw threaded into the threaded aperture and extending down to the pressure point.

3. The adjustable acupressure clamp according to claim 2, wherein the adjustment screw has a screw head extending above the top surface and further comprising a knob affixed to the screw head.

4. An adjustable acupressure clamp according to claim 1, wherein the user controlled means for restraining the variable resilient pressure between the upper arm and the lower arm comprises a rack and pinion mechanism.

5. An adjustable acupressure clamp according to claim 1, wherein the user controlled means for restraining the variable resilient pressure between the upper arm and the lower arm comprises a user controlled stop slidably disposed upon a bar.

6. An adjustable acupressure clamp according to claim 1, wherein the user controlled means for restraining the variable resilient pressure between the upper arm and the lower arm comprises a ratchet mechanism.

7. An adjustable acupressure clamp according to claim 6, wherein the ratchet mechanism comprises a releasable pawl engaging a toothed track.

8. An adjustable acupressure clamp according to claim 1, further comprising a cover substantially covering the user controlled means for restraining the variable resilient pressure between the upper arm and the lower arm.

9. The adjustable acupressure clamp according to claim 1, wherein at least one of the upper bulge and the lower bulge comprise malleable material.
